(19) United States
(12) Patent Application Publication
(10) Pub. No.: US 2014/0055378 A1
(43) Pub. Date: Feb. 27, 2014

(54) TOUCH PANEL AND METHOD FOR MANUFACTURING THE SAME

(71) Applicant: SAMSUNG ELECTRO-MECHANICS CO., LTD., Gyunggi-do (KR)

(72) Inventors: Hee Soo Kim, Gyunggi-do (KR); Sang Su Hong, Gyunggi-do (KR); Kang Heon Hur, Gyunggi-do (KR)

(73) Assignee: SAMSUNG ELECTRO-MECHANICS CO., LTD., Gyunggi-do (KR)

(21) Appl. No.: 13/664,143

(22) Filed: Oct. 30, 2012

(30) Foreign Application Priority Data
Aug. 22, 2012 (KR) 10-2012-0091944

(51) Int. Cl. G06F 3/041; H01H 11/00

(52) U.S. Cl. 345/173; 29/622

(57) ABSTRACT

Disclosed herein are a touch panel and a method for manufacturing the same, the touch panel including a transparent substrate; and a conductive part formed on the transparent substrate, wherein the conductive part is formed by coating silver salt emulsion layers having different photo-sensitivities on the transparent substrate such that the silver salt emulsion layers are laminated in multiple layers, followed by exposing/developing, so that electrical conductivity of the conductive part can be significantly improved.

### CROSS REFERENCE TO RELATED APPLICATION

This application claims the benefit of Korean Patent Application No. 10-2012-0091944, filed on Aug. 22, 2012, entitled “Touch Panel and Method for Manufacturing the Same”, which is hereby incorporated by reference in its entirety into this application.

### BACKGROUND OF THE INVENTION

1. Technical Field

The present invention relates to a touch panel and a method for manufacturing the same.

2. Description of the Related Art

With the development of computers using a digital technology, devices assisting computers have also been developed, and personal computers, portable transmitters and other personal information processors execute text and graphic processing using a variety of input devices such as a keyboard and a mouse.

While the rapid advancement of an information-oriented society has been widening the use of computers more and more, it is difficult to efficiently operate products using only a keyboard and mouse currently serving as an input device. Therefore, the need for a device that is simple, has minimum malfunction, and is capable of easily inputting information has increased.

In addition, current techniques for input devices have progressed toward techniques related to high reliability, durability, innovation, designing and processing beyond the level of satisfying general functions. To attain these objects, a touch panel has been developed as an input device capable of inputting information such as text, graphics, or the like.

The touch panel is mounted on the display surface of an image display device such as an electronic organizer, a flat panel display including a liquid crystal display (LCD), a plasma display panel (PDP), an electroluminescence (El) element or the like, or a cathode ray tube (CRT), so that a user selects the desired information while viewing the image display device.

The touch panel is classified into a resistive type touch panel, a capacitive type touch panel, an electromagnetic type touch panel, a surface acoustic wave (SAW) type touch panel, and an infrared type touch panel. These various types of touch panels are adapted for electronic products in consideration of signal amplification problems, resolution difference, level of difficulty of designing and processing technologies, optical characteristics, electrical characteristics, mechanical characteristics, environment-resistant characteristics, input characteristics, durability, and economic efficiency. Currently, a capacitive type touch panel and a digital resistive type touch panel have been used in a wide range of fields.

In this touch panel, electrodes for sensing a touch of a user and wirings for transmitting a signal generated from the electrodes to a controller are formed on a substrate. A conductive part such as the electrodes or wirings may be formed by exposing and developing a silver salt emulsion layer.

As an example of a constitution where a conductive part is formed by exposing and developing a silver salt emulsion layer, Japanese Patent Laid-Open Publication No. 2009-59998 discloses a ‘light transmissive conductive film’.

In most structures of the touch panel of the prior art where a conductive part is formed by exposing and developing a silver salt emulsion layer, including the above published patent, a silver (Ag) particle present in the conductive part is formed by the following procedure.

In the case where a silver salt contains, for example, AgBr, as silver halide, in a silver salt emulsion layer, a photon emitted from the light during an exposing step coverts a Br ion into a Br atom on a surface of the silver salt inside gelatin. Here, free electrons generated at this time combine with an Ag ion to form an Ag atom. Several Ag atoms generated through this procedure form Ag nuclei.

In a developing step, a developer reacts with AgBr to thereby form more Ag atoms, and the Br atoms generated at this time are dissolved in the developer. However, this reaction occurs on only the silver salt particle holding the Ag nuclei since the Ag nuclei function as a catalyst. Hence, the Ag nuclei are grown to Ag particles.

The thus formed conductive part containing Ag has high electric conductivity, and thus may be used as electrodes or wirings.

Meanwhile, in the structure of the touch panel of the prior art, an Ag particle structure of the conductive part formed by exposing and developing a silver salt emulsion layer will be described in detail with reference to FIGS. 1 to 3.

FIG. 1 is a schematic view showing that an Ag particle structure is differently formed according to the difference in light quantity depending on the depth of a silver salt emulsion layer. FIG. 2 is a two-dimensional view showing a simulation result confirming that the number of Ag nuclei is different at an upper portion and a lower portion of the conductive part. Further, FIG. 3 is a two-dimensional view explaining a growing procedure of Ag nuclei according to the change in time.

In the conductive part formed by exposing and developing a silver salt emulsion layer according to the prior art, it can be seen that an Ag particle 11 present in an upper portion of the conductive part retains an original shape of the silver salt particle. For example, in the case of using a silver salt of which particle shape is a cubic form, it can be confirmed that an Ag particle 11 formed by exposing and developing a silver salt emulsion layer has a grain structure where an original shape (cubic form) of the silver salt particle is retained the way it is. In addition, it can be seen that an Ag particle 12 present in a lower portion of the conductive part has a grain structure where the original shape of the silver salt particle is not retained.

The reason the Ag particles 11 and 12 present in the upper portion and lower portion of the conductive part have different grain structures results from an exposing process. As shown in FIG. 1, the light enables an Ag nucleus N on a surface of a silver salt 13 in an exposing step. At this time, the additively incident light is scattered by the Ag nucleus N or the like. Due to this, the deeper the depth of the silver salt emulsion layer, the less the quantity of light incident to the silver salt particle. Therefore, more Ag nuclei N are formed in the surface of the silver salt particle present in the upper portion of the conductive part receiving more quantity of light than in the surface of the silver salt particle present in the lower portion of the conductive part.

In FIG. 2, Case #1, Case #2, and Case #3 second-dimensionally show silver salt particles P1, P2, and P3 in areas A of an upper portion, a middle portion, and a lower portion of the conductive part, respectively. In the case of Case #1, it can be seen that approximately about 40 or more Ag nuclei N are formed on a surface of each silver salt particle P1. In the case of Case #2, it can be seen that approximately 3 Ag nuclei N are formed on a surface of each silver salt particle P2. Further, in the case of Case #3, it can be seen that 3 Ag nuclei N are formed on a surface of only one silver salt particle among silver salt particles P3 in the predetermined area A.

As shown in FIG. 3, in the silver salt particles P1 in the upper portion of the conductive part where many Ag nuclei N are formed, the Ag nuclei N grow only in an inside direction of the silver salt particle P1 (see, Case #1 in FIG. 3). Therefore, even after Ag is all reduced, the Ag particle 11 retains the original shape (cubic form) of the silver salt particle.

Whereas, in the silver salt particles P2 and P3 in the middle portion and the upper portion of the conductive part where relatively less Ag nuclei are formed, the Ag nuclei N diffusively grow out of the boundary of the original shape of the silver salt particle (see, Case #2 and Case #3 in FIG. 3). Therefore, the Ag particles 12 present in the middle portion and the lower portion of the conductive part have a grain structure where the original shape of the silver salt particle is not retained. Here, in the silver salt particle P3 present in the lowest portion of conductive part, Ag nucleation hardly occurs, and hence, the fewest Ag particles 12 are formed.

Meanwhile, in the Ag particle that is formed by exposing and developing a silver salt emulsion layer, it is preferable to form the Ag particle structure through a nuclei growing procedure shown in Case #2 in view of improving electrical conductivity of the conductive part. The reason is that, in the Ag particle formed through the nuclei growing procedure shown in Case #2, the distance between neighboring particles is short.

However, in the conductive part formed by exposing and developing a silver salt emulsion layer of the prior art, the Ag particle 11 present in the upper portion of the conductive part is formed to have a grain structure where the original shape of the silver salt particle is retained the way it is. In addition, these Ag particles 11 present in the upper portion of the conductive part do not contribute to the improvement in electrical conductivity of the conductive part due to the long distance therebetween.

Therefore, the Ag particles 11 present in the upper portion of the conductive part while retaining the original shape of the silver salt particle needs to be subjected to the nucleus growing procedure as shown in Case #2. In addition, in the lowest portion of the conductive part where Ag nucleation hardly occurs due to the reduction in light quantity, the generation of Ag nuclei needs to be promoted so that the number of Ag nuclei 12 is increased. In order to achieve this, in the step of exposing and developing the silver salt emulsion layer, the degree of Ag nucleation needs to be controlled. However, the touch panel structure according to the prior art fails to provide an appropriate means for controlling the generation of Ag nuclei.

### SUMMARY OF THE INVENTION

The present invention has been made in an effort to provide a touch panel where appropriate number of Ag particles having a grain structure not retaining an original shape of a silver salt particle are uniformly formed throughout upper and lower portions of a conductive part formed by exposing and developing a silver salt emulsion layer, to thereby improve electrical conductivity of the conductive part, and a method for manufacturing the same.

According to one preferred embodiment of the present invention, there is provided a touch panel, including: a transparent substrate; and a conductive part formed on the transparent substrate, wherein the conductive part is formed by coating silver salt emulsion layers having different photo-sensitivities on the transparent substrate such that the silver salt emulsion layers are laminated in multiple layers, followed by exposing/developing.

The silver salt emulsion layers may be composed of a first silver salt emulsion layer and a second silver salt emulsion layer, sequentially laminated on the transparent substrate, the first silver salt emulsion layer having higher photo-sensitivity than the second silver salt emulsion layer.

The silver salt emulsion layers may be composed of a first silver salt emulsion layer, a second silver salt emulsion layer, and a third silver salt emulsion layer, sequentially laminated on the transparent substrate, the first silver salt emulsion layer having higher photo-sensitivity than the second silver salt emulsion layer and the third silver salt emulsion layer and the second silver salt emulsion layer having higher photo-sensitivity than the third silver salt emulsion layer.

The silver salt emulsion layer may contain a silver salt having a cubic particle structure.

The conductive part may be formed in a mesh pattern.

The silver salt contained in the silver salt emulsion layer may be an inorganic silver salt.

According to another preferred embodiment of the present invention, there is provided a method for manufacturing a touch panel, the method including: (a) preparing a transparent substrate; (b) coating silver salt emulsion layers having different photo-sensitivities on the transparent substrate such that the silver salt emulsion layers are laminated in multiple layers; and (c) exposing/developing the silver salt emulsion layers laminated in multiple layers to thereby form a conductive part.

Here, in the stage (b), a first silver salt emulsion layer and a second silver salt emulsion layer may be sequentially coated on the transparent substrate.

The first silver salt emulsion layer may have higher photo-sensitivity than the second silver salt emulsion layer.

Here, in the stage (b), a first silver salt emulsion layer, a second silver salt emulsion layer, and a third silver salt emulsion layer may be sequentially coated on the transparent substrate.

The first silver salt emulsion layer may have higher photo-sensitivity than the second silver salt emulsion layer and the third silver salt emulsion layer and the second silver salt emulsion layer may have higher photo-sensitivity than the third silver salt emulsion layer.

The silver salt emulsion layer may contain a silver salt having a cubic particle structure.

Here, in the stage (c), the exposing may be performed by surface-exposing the silver salt emulsion layers using a photo-mask.

Here, in the stage (c), the exposing may be performed by scan-exposing the silver salt emulsion layers using a laser beam

The conductive part may be formed in a mesh pattern.

The silver salt contained in the silver salt emulsion layer may be an inorganic silver salt.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic view showing that an Ag particle structure is differently formed according to the difference in light quantity depending on the depth of a silver salt emulsion layer;

FIG. 2 is a two-dimensional view showing a simulation result confirming that the number of Ag nuclei is different at an upper portion and a lower portion of a conductive part;

FIG. 3 is a two-dimensional view showing a growing procedure of Ag nuclei shown in FIG. 2;

FIG. 4 is a cross-sectional view of a touch panel according to a preferred embodiment of the present invention; and

FIG. 5 is a view explaining a process for forming a conductive part shown in FIG. 4.

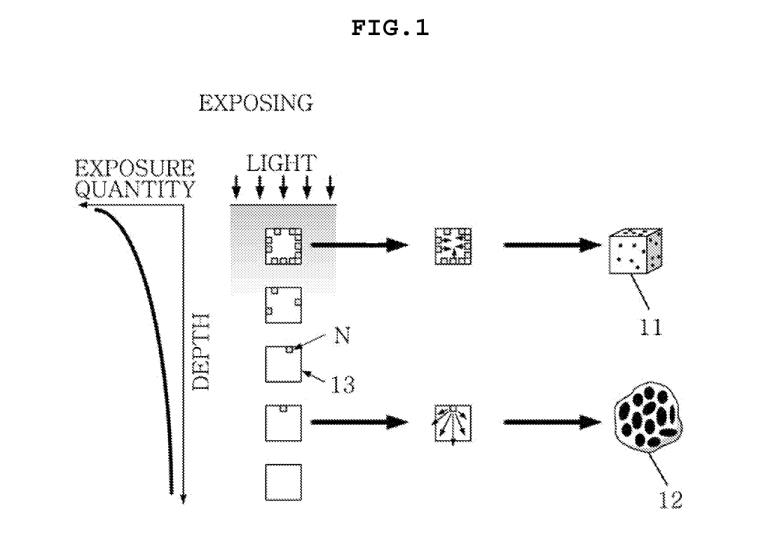

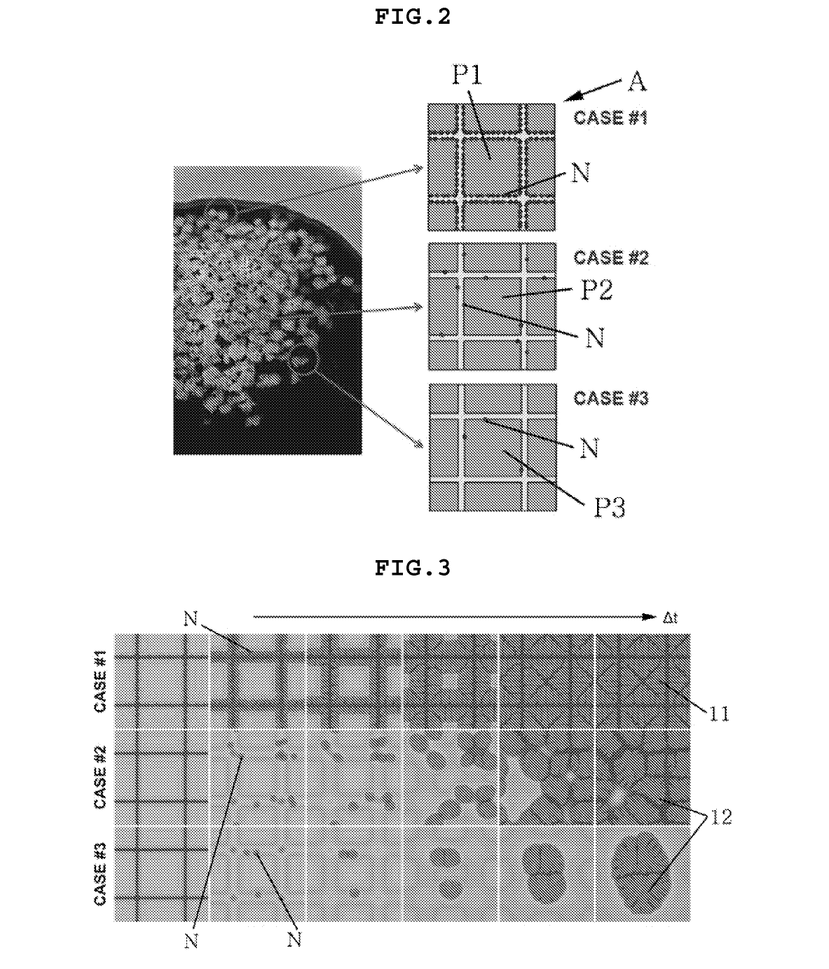

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

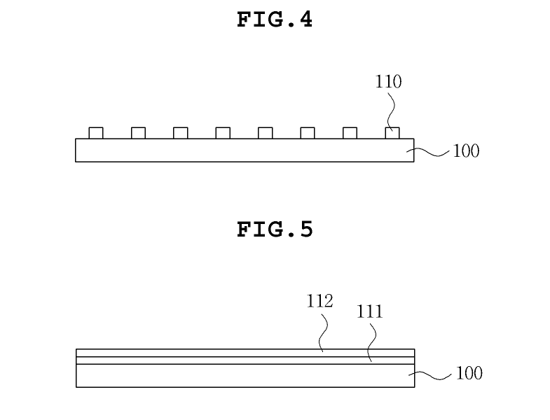

FIG. 4 is a cross-sectional view of a touch panel according to a preferred embodiment of the present invention; and FIG. 5 is a view explaining a process for forming a conductive part shown in FIG. 4.

As shown in FIGS. 4 and 5, a touch panel according to a preferred embodiment of the present invention may include a transparent substrate 100, and conductive parts 110 formed on the transparent substrate 100. Here, the conductive parts 110 are formed by coating silver salt emulsion layers having different photo-sensitivities to be laminated in multiple layers, followed by exposing and developing.

The transparent substrate 100 serves to provide an area in which the conductive parts 110 to be described below is to be formed. The transparent substrate 100 needs to have a support force for supporting the conductive parts 110 and transparency for allowing a user to recognize an image provided by an image display device.

In consideration of the above-described support force and transparency, the transparent substrate 100 is preferably formed of polyethyleneterephthalate (PET), polycarbonate (PC), polymethylmethacrylate (PMMA), polyethylenenaphthalate (PEN), polyethersulfone (PES), cyclic olefin copolymer (COC), triacetylcellulose (TAC) film, polyvinyl alcohol (PVA) film, polyimide (PI) film, polystyrene (PS), biaxially oriented polystyrene (BOPS; containing K resin), glass or reinforced glass, and so on, but is not particularly limited thereto.

Meanwhile, the transparent substrate 100 may be a window provided at the outermost side of the touch panel. In the case where the transparent substrate 100 is the window, since the conductive parts 110 to be described below are formed directly on the window, processes of forming the conductive parts 110 on a separate transparent substrate 100 and then attaching the transparent substrate 100 to the window are omitted, and the overall thickness of the touch panel may be decreased.

The conductive parts 110 may be formed on one surface of the transparent substrate 100, and may have electric conductivity. This conductive part 110 may be used as electrodes or wirings. Alternatively, some of the conductive parts 110 may be used as electrodes or other of the conductive parts 110 may be used as wirings.

The above-described electrodes serve to generate a signal when being touched by a user, to thereby allow the touched coordinate to be recognized by a controller (not shown). In the case where the conductive part 110 is used as an electrode, the conductive part 110 may be formed in a mesh pattern in consideration of visibility of the touch panel. The wirings serve to transmit the touch signal generated from the above-described electrodes to the controller. One end of the wiring is electrically connected to the electrode and the other end of the wiring is electrically connected to a flexible printed circuit board (FPCB) connected to the controller.

The conductive parts 110 are formed by exposing/developing a silver salt emulsion layer. The silver salt emulsion layer contains a silver salt and a binder, and further contains an additive such as a solvent, a dye, or the like.

The silver salt may be an inorganic silver salt such as silver halide or the like, or an organic silver salt such as silver acetate.

As the binder, for example, gelatin, polyvinyl alcohol (PVA), polyvinyl pyrrolidone (PVP), polysaccharides such as starch, cellulose and its derivatives, polyethylene oxide, polyvinyl amine, chitosan, poly-lysine, polyacrylic acid, poly alginic acid, poly hyaluronic acid, carboxy cellulose, or the like may be used.

There is no particular limitation as to the solvent, but for example, water, an organic solvent (e.g., alcohols such as methanol and the like, ketones such as acetone and the like, amides such as formamide and the like, sulfoxides such as dimethyl sulfoxide and the like, esters such as ethyl acetate and the like, ethers, or the like), an ionic liquid, and a mixture solvent thereof may be used.

There is no particular limitation as to the other additive, but ones that are known may be preferably used.

Here, the conductive parts 110 of the present embodiment are formed by coating silver salt emulsion layers having different photo-sensitivities on the transparent substrate 100 such that the silver salt emulsion layers are laminated in multiple layers, followed by exposing and developing.

More specifically, a method for manufacturing a touch panel according to the present preferred embodiment includes: (a) preparing a transparent substrate 100, (b) coating silver salt emulsion layers having different photo-sensitivities to be laminated in multiple layers on the transparent substrate 100, and (c) exposing/developing the silver salt emulsion layers laminated in multiple layers to form conductive parts 110.

Here, in the stage (b), for example, as shown in FIG. 5, a first silver salt emulsion layer 111 and a second silver salt emulsion layer 112 having different photo-sensitivities may be sequentially coated on the transparent substrate 100, so that two layers of the silver salt emulsion layers are laminated.

Here, the conductive part 110 may be formed into a mesh pattern during the stage (c), that is, the stage of pattern-exposing and developing the first silver salt emulsion layer 111 and the second silver salt emulsion layer 112 in a mesh shape.

As a specific method of pattern-exposing the first silver salt emulsion layer 111 and the second silver salt emulsion layer 112, surface-exposing using a photo-mask, scan-exposing using a laser beam, or the like may be employed. Alternatively, various methods such as refractive exposing using a lens, reflective exposing using a reflecting mirror, contact exposing, proximity exposing, reduction-projection exposing, reflection-projection exposing, and the like may be used.

The developing treatment may be additively performed after the first silver salt emulsion layer 111 and the second silver salt emulsion layer 112 are pattern-exposed as described above. A conventional developing treatment used in a silver salt photo film or a photographic paper, a film for printing plate, emulsion mask for photo-mask, and the like.

Meanwhile, the first silver salt emulsion layer 111 and the second silver salt emulsion layer 112 may have different photo-sensitivities. Specifically, the first silver salt emulsion layer 111 may have high photo-sensitivity by a method such as chemical sensitization or the like. In addition, the second silver salt emulsion layer 112 may have relatively lower photo-sensitivity as compared with the first salt emulsion layer 111.

In the exposing step, the light reaches the second silver salt emulsion layer earlier 112, and then reaches the first silver salt emulsion layer 111.

Since the second silver salt emulsion layer 112 of the present embodiment has low photo-sensitivity, excessive silver (Ag) nucleation does not occur on the silver salt particle of the second silver salt emulsion layer 112. Therefore, in the case where the silver salt particle included in the second silver salt emulsion layer 112 has, for example, a cubic shape or an anisotropic shape, the Ag particle formed by exposing/developing processes has a grain structure where the original shape of the silver salt particle is not retained (hereinafter, referred to as a “first grain structure), due to diffusive growing of the Ag nuclei. However, all the Ag particles formed by exposing/developing the second silver salt emulsion layer 112 do not have only a first grain structure. Some of the Ag particles may have a cubic grain structure where the shape of the silver salt particle is retained (hereinafter, referred to as a “second grain structure). However, according to the present embodiment, even though these Ag particles having a second gain structure, the number thereof may be little.

Meanwhile, the first sliver salt emulsion layer 111 is positioned in a layer lower than the second silver salt emulsion layer 112. However, as described above, the first silver salt emulsion layer 111 has higher photo-sensitivity than the second silver salt emulsion layer 112, and thus, Ag nucleation may be promoted in the silver salt particles positioned at the lowest portion of the first silver salt emulsion layer 111. In addition, this promotion of Ag nucleation results from the reduction in scattering of incident light, since excessive Ag nucleation does not occur in the second silver salt emulsion layer 112. Therefore, the number of Ag particles having a first grain structure may be appropriate in the conductive part 110 according to the present embodiment, including the lowest portion of the conductive part 110.

In the thus formed conductive part 110, the Ag particles having a first grain structure are uniformly formed throughout the upper and lower portions of the conductive part 110. In addition, these Ag particles have short distances from neighboring particles, resulting in significant improvement in electrical conductivity of the conductive part 110.

Meanwhile, the stage (b) is not limited to the above-described embodiment. That is, it is not necessary to coat the silver salt emulsion layer in two layers.

For example, in the stage (b), a first silver salt emulsion layer, a second silver salt emulsion layer, and a third silver salt emulsion layer, having different photo-sensitivities, may be sequentially coated.

In this case, the first silver salt emulsion layer constituting the lowest layer may have highest photo-sensitivity, and the third silver salt emulsion layer positioned in the highest layer may have lowest photo-sensitivity. That is, the first silver salt emulsion layer has higher photo-sensitivity than the second and third silver salt emulsion layers, and the second silver salt emulsion layer constituting the middle layer may have higher photo-sensitivity than the third silver salt emulsion layer.

Even in the case where a silver salt emulsion layer coated on the transparent substrate 100 has the above constitution, the conductive part 110 formed in the stage (c) may have Ag particles having a first grain structure while the Ag particles being uniformly formed throughout the upper and lower portions thereof.

In the stage (b), silver salt emulsion layers having different photo-sensitivities may be coated such that they are laminated in four or more layers. In the silver salt emulsion layers formed by this stage, the photo-sensitivity is higher toward the lower layer and the photo-sensitivity is lower toward the higher layer.

As set forth above, the Ag particles formed by exposing/developing the silver salt emulsion layer have a grain structure where the original shape of the silver salt particle is not retained, due to diffusive growing of Ag nuclei. In addition, since Ag nucleation is promoted even in the silver salt emulsion layer positioned in the lowest layer of the conductive part, appropriate number of Ag particles having this grain structure can be uniformly formed throughout the upper and lower portions of the conductive part.

The Ag particles having this grain structure have a very short distance therebetween. Hence, according to the present invention, electrical conductivity of the conductive part can be significantly improved.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch panel, comprising:
a transparent substrate; and
a conductive part formed on the transparent substrate,
wherein the conductive part is formed by coating silver salt emulsion layers having different photo-sensitivities on the transparent substrate such that the silver salt emulsion layers are laminated in multiple layers, followed by exposing/developing.

2. The touch panel as set forth in claim 1, wherein the silver salt emulsion layers are composed of a first silver salt emulsion layer and a second silver salt emulsion layer, sequentially laminated on the transparent substrate, the first silver salt emulsion layer having higher photo-sensitivity than the second silver salt emulsion layer.

3. The touch panel as set forth in claim 1, wherein the silver salt emulsion layers are composed of a first silver salt emulsion layer, a second silver salt emulsion layer, and a third silver salt emulsion layer, sequentially laminated on the transparent substrate, the first silver salt emulsion layer having higher photo-sensitivity than the second silver salt emulsion layer and the third silver salt emulsion layer and the second silver salt emulsion layer having higher photo-sensitivity than the third silver salt emulsion layer.

4. The touch panel as set forth in claim 1, wherein the silver salt emulsion layer contains a silver salt having a cubic particle structure or an anisotropic particle structure.

5. The touch panel as set forth in claim 1, wherein the conductive part is formed in a mesh pattern.

6. The touch panel as set forth in claim 1, wherein the silver salt contained in the silver salt emulsion layer is an inorganic silver salt.

7. A method for manufacturing a touch panel, the method comprising:
(a) preparing a transparent substrate;
(b) coating silver salt emulsion layers having different photo-sensitivities on the transparent substrate such that the silver salt emulsion layers are laminated in multiple layers; and
(c) exposing/developing the silver salt emulsion layers laminated in multiple layers to thereby form a conductive part.

8. The method as set forth in claim 7, wherein in the stage (b), a first silver salt emulsion layer and a second silver salt emulsion layer are sequentially coated on the transparent substrate.

9. The method as set forth in claim 8, wherein the first silver salt emulsion layer has higher photo-sensitivity than the second silver salt emulsion layer.

10. The method as set forth in claim 7, wherein in the stage (b), a first silver salt emulsion layer, a second silver salt emulsion layer, and a third silver salt emulsion layer are sequentially coated on the transparent substrate.

11. The method as set forth in claim 10, wherein the first silver salt emulsion layer has higher photo-sensitivity than the second silver salt emulsion layer and the third silver salt emulsion layer and the second silver salt emulsion layer has higher photo-sensitivity than the third silver salt emulsion layer.

12. The method as set forth in claim 7, wherein the silver salt emulsion layer contains a silver salt having a cubic particle structure or an anisotropic particle structure.

13. The method as set forth in claim 7, wherein in the stage (c), the exposing is performed by surface-exposing the silver salt emulsion layers using a photo-mask.

14. The method as set forth in claim 7, wherein in the stage (c), the exposing is performed by scan-exposing the silver salt emulsion layers using a laser beam.

15. The method as set forth in claim 7, wherein the conductive part is formed in a mesh pattern.

16. The method as set forth in claim 7, wherein the silver salt contained in the silver salt emulsion layer is an inorganic silver salt.
